(19) United States
(12) Patent Application Publication
(10) Pub. No.: US 2009/0325593 A1
(43) Pub. Date: Dec. 31, 2009

(54) Marking Locations With A Portable Communications Device

(75) Inventors: Phuc K. Do, Morrisville, NC (US); Justin M. Pierce, Cary, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/146,079

(22) Filed: Jun. 25, 2008

(51) Int. Cl. G08B 13/00

(52) U.S. Cl. 455/456.1

(57) ABSTRACT

Marking locations with a portable communications device, where the portable communications device has a location-sensing capability, including recording, by the portable communications device for each wireless device with which the portable communications device is capable of wireless communications, a location of the portable communications device upon receiving from the wireless device a signal having a most recent strongest signal strength and an identifier of the wireless device, and, responsive to a user request, communicating to the user the location of the portable communications device upon receiving from the wireless device a signal having a most recent strongest signal strength.

### BACKGROUND OF THE INVENTION

1. Field of the Invention

The field of the invention is data processing, or, more specifically, methods, apparatus, and products for marking locations with a portable communications device.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago. One of the areas that has seen considerable advancement is location-specific services. Portable devices, cell phones, PDAs, laptop computers, and so on, can be equipped with GPS receivers, Bluetooth transceivers, and the like, that support intelligent provision of data processing services according to the physical location of such a portable device.

### SUMMARY OF THE INVENTION

Methods, apparatus, and computer program products are described for marking locations with a portable communications device, where the portable communications device has a location-sensing capability, including recording, by the portable communications device for each wireless device with which the portable communications device is capable of wireless communications, a location of the portable communications device upon receiving from the wireless device a signal having a most recent strongest signal strength and an identifier of the wireless device, and, responsive to a user request, communicating to the user the location of the portable communications device upon receiving from the wireless device a signal having a most recent strongest signal strength.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a data processing system for marking locations with a portable communications device according to embodiments of the present invention, including a functional block diagram of automated computing machinery comprising an exemplary portable communications device.

FIG. 2 sets forth a flow chart illustrating an exemplary method of marking locations with a portable communications device according to embodiments of the present invention.

FIG. 3 sets forth a flow chart illustrating a further exemplary method for marking locations with a portable communications device according to embodiments of the present invention.

### DETAILED DESCRIPTION OF EXEMPLARY EMBODIMENTS

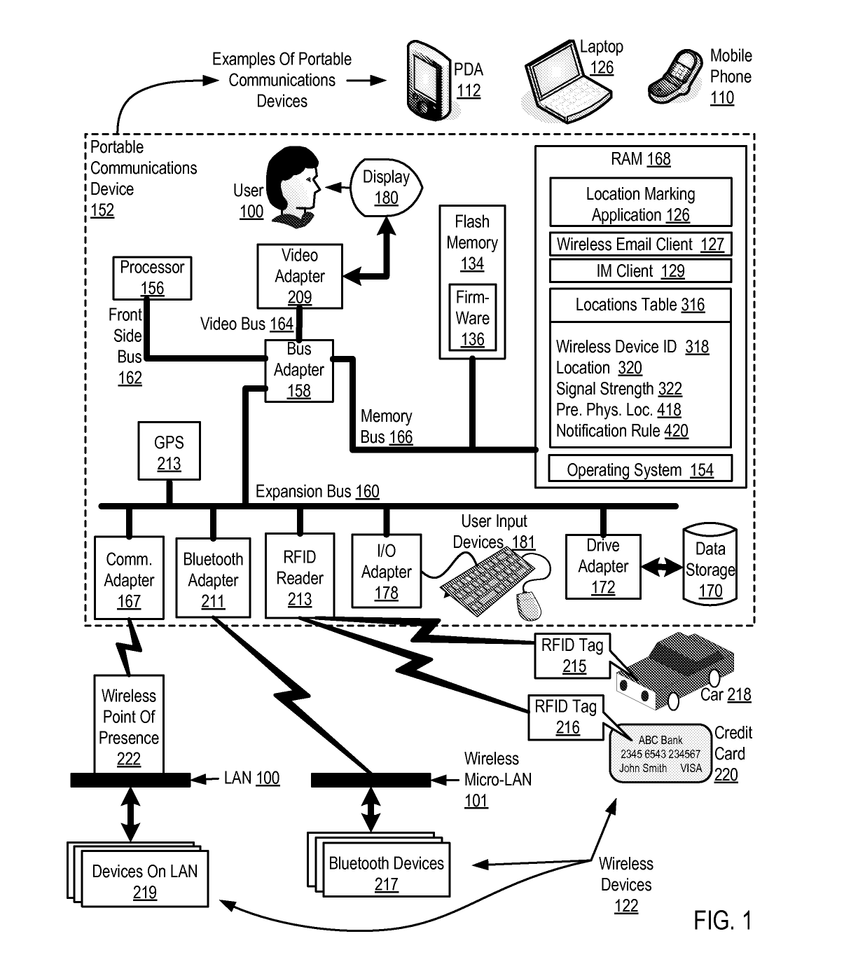

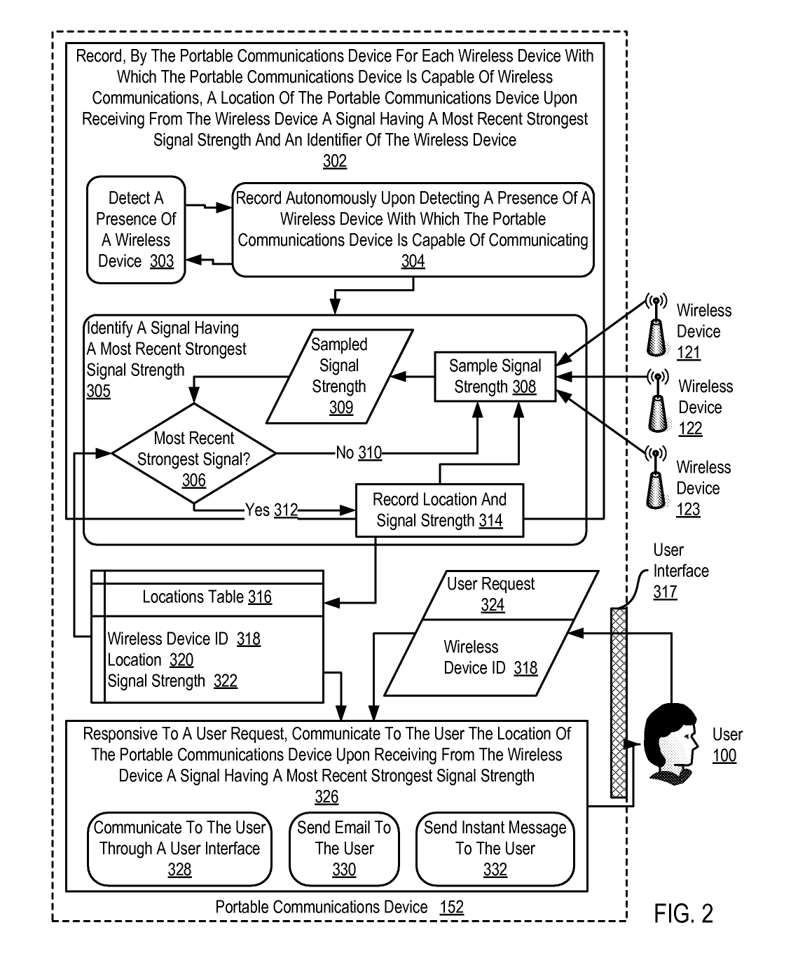

Exemplary methods, apparatus, and products for marking locations with a portable communications device in accordance with the present invention are described with reference to the accompanying drawings, beginning with FIG. 1. FIG. 1 sets forth a network diagram of a data processing system for marking locations with a portable communications device according to embodiments of the present invention, including a functional block diagram of automated computing machinery comprising an exemplary portable communications device (152). The functional block diagram in this example, for ease of explanation, illustrates a generic portable communications device (152) for marking locations according to embodiments of the present invention. A ‘portable communications device,’ as the term is used in this specification, is any device capable of wireless communications with another device, improved for marking locations according to embodiments of the present invention. Many portable communications devices can be improved for use in location marking according to the method of FIG. 2, including any portable communications device with location sensing capability, memory, and programming capacity. Examples of specific portable communications devices that can be improved for marking locations according to embodiments of the present invention include personal digital assistants (112), laptop computers (126), mobile telephones (110), as well as other portable communications devices as will occur to those of skill in the art.

The fact that a portable communications device is capable of wireless communications with a wireless device does not necessarily mean that information flows between the portable communications device and the wireless device. On the contrary, ‘wireless communications’ as the term is used in this specification includes the possibility that a portable communications device detects the presence of a wireless device by detecting a wireless signal emanating from the wireless device without ever transferring any information to or from the wireless device. In such a case, in the absence of any information from the wireless device regarding the identity of the wireless device, a user can identify the wireless device through a user interface of the portable communications device, for example.

The portable communications device (152) of FIG. 1 includes at least one computer processor (156) or ‘CPU’ as well as random access memory (168) (‘RAM’) which is connected through a high speed memory bus (166) and bus adapter (158) to processor (156) and to other components of the portable communications device (152).

Stored in RAM (168) is a location marking application (126), a module of computer program instructions that, when executed on processor (156), causes the portable communications device (152) to mark locations in accordance with embodiments of the present invention. Also stored RAM (168) is a locations table (316), a data structure used by the location marking application (126) for marking locations according to embodiments of the present invention.

In the example of FIG. 1, the portable communications device has a location-sensing capability, GPS transceiver (213), for use in marking locations according to embodiments of the present invention. The GPS transceiver (213) provides a direct indication of the physical location of the portable communications device. Triangulation technology can be included in such a portable communications device to provide an indirect indication of the physical location of the portable communications device based on signals from other wireless devices. Such triangulation technology may be implemented, for example, as a wireless triangulation capability utilizing the strength of received signals and mathematical algorithms to determine the location of a portable communications device. Other forms of location-sensing capability may occur to those of skill in the art, and the use of all such forms for marking locations is well within the scope of the present invention.

In this example, the portable communications device operates generally under control of the location marking application (126) and the processor (156) to mark locations according to embodiments of the present invention by recording in the locations table (316), for each wireless device (122) with which the portable communications device is capable of wireless communications, a location (320) of the portable communications device (152) upon receiving from the wireless device a signal having a most recent strongest signal strength. The portable communications device also records in the locations table (316) the most recent strongest signal strength (322) for each such wireless device along with an identifier (318) for each such wireless device. Recording the most recent strongest signal strength enables a determination whether a subsequently sampled signal strength is in fact the most recent strongest signal strength—by comparison with the recorded strength of a previously sampled signal. Recording the location of the portable communications device, determined from its location-sensing capability GPS transceiver (213), upon receiving the most recent strongest signal from a wireless device takes the location of the portable communications device at that time as the location of that wireless device—because the location of the portable communications device when the signal from the wireless device is strongest indicates the location of the wireless device.

The example of FIG. 1 includes several kinds of wireless devices (122), devices (219) on a local area network (‘LAN’) (100), Bluetooth-enabled devices (217), a car (218) bearing an RFID tag (215), and a credit card (220) bearing an RFID tag (216). The devices (219) on a local area network (‘LAN’) (100) are ‘wireless devices’ within the meaning of the present invention because the LAN to which they are connected supports a wireless point of presence (222). The wireless point of presence (222) is a wireless router port or the like through which wireless devices can connect to the LAN (100). Any particular device (219) connected to the LAN (100) can connect through a wireline or wirelessly, but because of the ‘local’ nature of the LAN, all devices connected to the LAN have sufficient physical proximity to support location marking according to embodiments of the present invention, with the portable communications device recording locations and advising users of those locations upon request. The car (218) bearing an RFID tag (215) and the credit card (220) bearing an RFID tag (216) are wireless devices within the meaning of the present invention because the portable communications device (152) through its RFID reader (213) can sample and measure a most recent strongest signal strength from each such RFID tag (215, 216) for use in marking locations according to embodiments of the present invention.

Although for ease of explanation only a few wireless devices are illustrated in FIG. 1, readers will recognize that in fact the portable communications device will often come into wireless proximity with any number of wireless devices. The portable communications device will be able to communicate with some of these wireless devices and not with others. The portable communications device may be within the wireless proximity of multiple RFID tags, for example, at least some of which are encoded with information that is unintelligible to the portable communications device. A portable communications device may be implemented with an RFID transceiver but no Bluetooth transceiver, or the other way round, so that the portable communications device is able to communicate with other devices having RFID tags but not with Bluetooth devices, and so on. In accord with embodiments of the present invention, the portable communications device recognizes any and all wireless devices with which the portable communications device can communicate and, upon detecting a presence of a wireless device with which the portable communications device is capable of communicating, without human intervention, autonomously records a location where it receives for each such wireless device a most recent strongest signal, thereby effectively recording the location of each such wireless device with which the portable communications device can communicate.

In the example of FIG. 1, the portable communications device includes a notification rule (420). A notification rule is a specification of one or more notification requirements regarding a specific wireless device and a predetermined physical location. The location marking application (126) is also configured to operate the portable communications device to identify, at the behest of a user, a location of a wireless device at a predetermined location for application of a notification rule and associate a notification rule with the predetermined location. The location marking application (126) can receive such requests from a user through the user interface (181) described above. The location marking application can then operate iteratively to mark locations according to embodiments of the present invention by determining whether the portable communications device is presently located at a predetermined location, determining whether the portable communications device is presently capable of communicating with the specific wireless device, and notifying the user whether the portable communications device is presently located at the predetermined location and whether the portable communications device is presently capable of communicating with the specific wireless device as specified by the requirements of the rule. Examples of such notification rules include:
Rule: If I am not in the vicinity of my home, notify me if a particular wireless device is more than 15 feet away from my cell phone. Explanation: The cell phone is a portable communication device according to embodiments of the present invention and ‘more than 15 feet away’ is taken as a predetermined location—useful, for example, to obtain a notification of a credit card loss when a credit card bearing an RFID tag is found to be more than 15 feet away from a user who always carries both her cell phone and her credit card in her handbag. The rule is configured to suppress notifications when the user is at home—where they may stow said handbag while continuing to carry around the phone.
Rule: Notify me when my daughter's arrives on her way home from school at a particular bus stop and a particular time. Explanation: The daughter carries a portable communications device such as a cell phone and her bus stop is equipped with an RFID tag, a wireless point of presence for a LAN connection, or a Bluetooth transceiver, for example.
   These two notification rules are chosen only for clarity of explanation. Other notification rules will occur to those of skill in the art, and the use of all such notification rules are well within the scope of the present invention.

Also stored in RAM (168) is an operating system (154). Operating systems useful for marking locations with a portable communications device according to embodiments of the present invention include UNIX™, Linux™, Microsoft XP™, AIX™, IBM's i5/OS™, and others as will occur to those of skill in the art. The operating system (154), the location marking application (126), and the locations table (316) in the example of FIG. 1 are shown in RAM (168), but many components of such software typically are stored in non-volatile memory also, such as, for example, on a disk drive (170).

The portable communications device (152) of FIG. 1 includes disk drive adapter (172) coupled through expansion bus (160) and bus adapter (158) to processor (156) and other components of the portable communications device (152). Disk drive adapter (172) connects non-volatile data storage to the portable communications device (152) in the form of disk drive (170). Disk drive adapters useful in portable communications devices that mark locations according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory (134)), RAM drives, and so on, as will occur to those of skill in the art.

The example portable communications device (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. To the extent that such user input devices are Bluetooth-enabled, a Bluetooth adapter (211) represents an alternative way for such user input devices to provide user-oriented input/output for the portable communications device (152). The example portable communications device (152) of FIG. 1 also includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus. The user input devices (181) and the display (180) implement a user interface for the portable communications device through which a user (100) can issue requests for locations and through which the portable communications device can communicate locations to the user.

Through a user interface, such as the one represented by the video display (180) in this example, the portable communications device, under the control of the location marking application (126), responsive to a user request to do so, can communicate to the user (100) the location of the portable communications device upon receiving from a wireless device a signal having a most recent strongest signal strength. The location so reported is not the portable communications device's current location, but is rather the location (320) of the portable communications device as recorded in the locations table (316) at the time when the portable communications device (152) received the most recent strongest signal (322), that is, actually in effect the recorded location for the wireless device in question.

The portable communications device in the example of FIG. 1 also has disposed in its RAM (168) a wireless email client (127), a module of computer program instructions that implement user-level computer operations for sending and receiving electronic mail messages. The wireless email client (127) exposes a programming interface (not shown), accessible by the location marking application (126) that enables operation of the wireless email client for sending email message by the location marking application. In this way, the location marking application, in addition to the use of the user interface (180, 181) for communicating location to a user, also can communicate a location to a user by use of an email message. The portable communications device illustrated in the example of FIG. 1 includes a user interface, a keyboard, mouser, video display, and so on, but the presence of a user interface is not a requirement of location marking according to the present invention. Compact, special purpose embodiments of such a portable communications device in particular may have no user interface whatsoever—can still autonomously record locations—and can still receive requests and communicate locations to a user through use of a wireless email client.

The portable communications device in the example of FIG. 1 also has disposed in its RAM (168) an instant messaging (‘IM’) client (129), a module of computer program instructions that implement user-level computer operations for sending and receiving instant messages. The IM client (129) exposes a programming interface (not shown), accessible by the location marking application (126) that enables operation of the IM client for sending instant message by the location marking application. In this way, the location marking application, in addition to the use of the user interface (180, 181) for communicating location to a user, also can communicate a location to a user by use of an instant message. The portable communications device illustrated in the example of FIG. 1 includes a user interface, a keyboard, mouser, video display, and so on, but the presence of a user interface is not a requirement of location marking according to the present invention. Compact, special purpose embodiments of such a portable communications device in particular may have no user interface whatsoever—can still autonomously record locations—and can still receive from a user requests for locations and can still communicate locations to a user through use of an IM client (129).

The example portable communications device (152) of FIG. 1 includes a communications adapter (167) for data communications with wireless devices (122), in this example, through a wireless point of presence (222) on a LAN (100). Such data communications may be carried out data communications data communications networks such as Internet Protocol (‘IP’) data communications networks, and in other ways as will occur to those of skill in the art. Communications adapters implement the hardware level of data communications through which one device or computer sends data communications to another device or computer, directly or through a data communications network. Examples of communications adapters useful for marking locations with a portable communications device according to embodiments of the present invention include 802.11 adapters for wireless data communications. The communication adapter (167) in this example is configured to measure the signal strength of wireless signals from the wireless point of presence (222), and, upon request from the location marking application (126), report to the location marking application (126) the signal strength of a wireless signal from the wireless point of presence (222).

The example portable communications device (152) of FIG. 1 includes a Bluetooth adapter (211), an example of a communications adapter configured to implement a Bluetooth microLAN (101) with other Bluetooth-enabled devices (217). The Bluetooth adapter (211) in this example is configured to measure the signal strength of wireless signals from other Bluetooth devices (217), and, upon request from the location marking application (126), report to the location marking application (126) the signal strength of a wireless signal from another Bluetooth-enabled device (217).

The example portable communications device (152) of FIG. 1 includes an RFID reader (213), an example of a communications adapter configured to read digital information from an RFID tag (215, 216). The RFID reader (213) in this example is configured to measure the signal strength of wireless signals from RFID tags (215, 216), and, upon request from the location marking application (126), report to the location marking application (126) the signal strength of a wireless signal from such RFID tags (215, 216).

For further explanation, FIG. 2 sets forth a flow chart illustrating an exemplary method of marking locations with a portable communications device (152) according to embodiments of the present invention. The method of FIG. 2 is implemented with a portable communications device (152) similar to those described above in this specification.

The method of FIG. 2 includes recording (302), by the portable communications device (152) for each wireless device (121, 122, 123) with which the portable communications device is capable of wireless communications, a location (320) of the portable communications device upon receiving from the wireless device a signal having a most recent strongest signal strength and an identifier of the wireless device.

Although for ease of explanation only three wireless devices (121, 122, 123) are illustrated in FIG. 2, readers will recognize that in fact the portable communications device will often come into wireless proximity with any number of wireless devices, some of which the portable communications device may be able to read, others not. The portable communications device may be within the wireless proximity of multiple RFID tags, for example, many of which may be encoded with information that is unintelligible to the portable communications device. A portable communications device may be implemented with an RFID transceiver but no Bluetooth transceiver, or the other way round, so that the portable communications device is able to communicate with other devices having RFID tags but not with Bluetooth devices, and so on. In accord with embodiments of the present invention, the portable communications device recognizes any and all wireless devices with which the portable communications device can communicate and, without human intervention, automatically records a location where it receives for each such wireless device a most recent strongest signal from each such device, thereby effectively recording the location of each wireless device with which the portable communications device can communicate.

Recording (302) a location of the portable communications device (152) upon receiving a signal having a most recent strongest signal strength and an identifier of the wireless device is carried out in this example by storing the information in a locations table (314). Each record in the locations table (316) represents a wireless device with which the portable communications device can communicate. Each record in the locations table associates with an identifier (318) of a wireless device a location (320) of the portable communications device upon receiving a most recent strongest signal from the identified wireless device and a measure (322) of the strength of the most recent strongest signal from the wireless device.

In the method of FIG. 2, recording a location of the portable communications device upon receiving a most recent strongest may include identifying (305) a most recent strongest signal by iteratively sampling (308) the signal strength of signals from wireless devices with which the portable communications device (152) can communicate and determining (306) whether a sampled signal strength (309) is stronger than a previously recorded most recent strongest signal strength (322) for each such wireless device. If the sampled signal strength (309) is stronger (312) than a previously recorded most recent strongest signal strength (322), then the portable communications device records (314) the sampled signal strength (309) as a new value for the most recent strongest signal strength (322), as well as recording the present location of the portable communications device as a new value of the location (320) of the portable communications device upon receiving a most recent strongest signal. If the sampled signal strength (309) is not stronger (310) than a previously recorded most recent strongest signal strength (322), then the portable communications device drops the current sample without recording it and continues iteratively sampling (308) and determining (306) whether a current sample is stronger than a previously recorded strongest signal.

For further explanation, note that as a starting point, when a portable communications device first detects the presence of a wireless device with which it can communicate, the portable communications device can sample the strength of the signal from the wireless device and record that signal strength as the most recent strongest signal strength (322)—along with the location (320) of the portable communications device at that time. When a subsequent sampling of the signal strength shows a stronger signal, the portable communications device is moving toward the wireless device in question, and the portable communications device iteratively records subsequent signal strengths (322) and their associated locations (320) as long as the portable communications device is moving toward the wireless device, that is, until the portable communications device samples a signal from a wireless device having a strength less than the most recently recorded signal strength for that wireless device. Now the portable communications device is moving away from the subject wireless device, and the most recently recorded signal strength is the most recent strongest signal strength for that wireless device—permanently—unless the portable communications device at some point in the future somehow moves even closer to the wireless device—at which time the portable communications device would again record a new most recent strongest signal (322) and an associated location (320) of the portable communications device. Such a location represents the closest proximity of the portable communications device to the wireless device and is taken as a representation of the location of the wireless device itself.

The method of FIG. 2 includes recording (304) autonomously upon detecting a presence of a wireless device with which the portable communications device is capable of communicating. The recording is ‘autonomous’ in the sense that, optionally at least, the portable communications device operates to mark locations by determining without human intervention whether a detected wireless device is a wireless device with which the portable communications device can communicate, and, if it is, recording an identifier for the wireless device along with a location and a most recent signal strength. In the method of FIG. 2, the portable communications device (152) iteratively detects (303) the presence of a wireless device (121, 122, 123), records (304) autonomously without user intervention, and subsequently determines (305) whether the signal received from such a device is the most recent strongest signal as described above.

The method of FIG. 2 includes communicating (326) to a user, in response to a request from the user to do so, the location (320) of the portable communications device (152) upon receiving from the wireless device a signal having a most recent strongest signal strength. In the method of FIG. 2, the user request (324) includes a wireless device identifier (318). The portable communications device of FIG. 2 retrieves the location of the portable communications device upon receiving the most recent strongest signal from a wireless device by performing a lookup in the locations table (316) with the wireless device identifier (318). In the method of FIG. 2, the portable communications device includes a user interface (317), a GUI or a command line interface, for example, and the portable communications device can communicate (328) the location (320) of the portable communications device upon receiving from a wireless device a signal having a most recent strongest signal strength to the user through the user interface (317). Alternatively, the portable communications device can communicate the requested location by sending (330) email to the user or by sending (332) an instant message to the user.

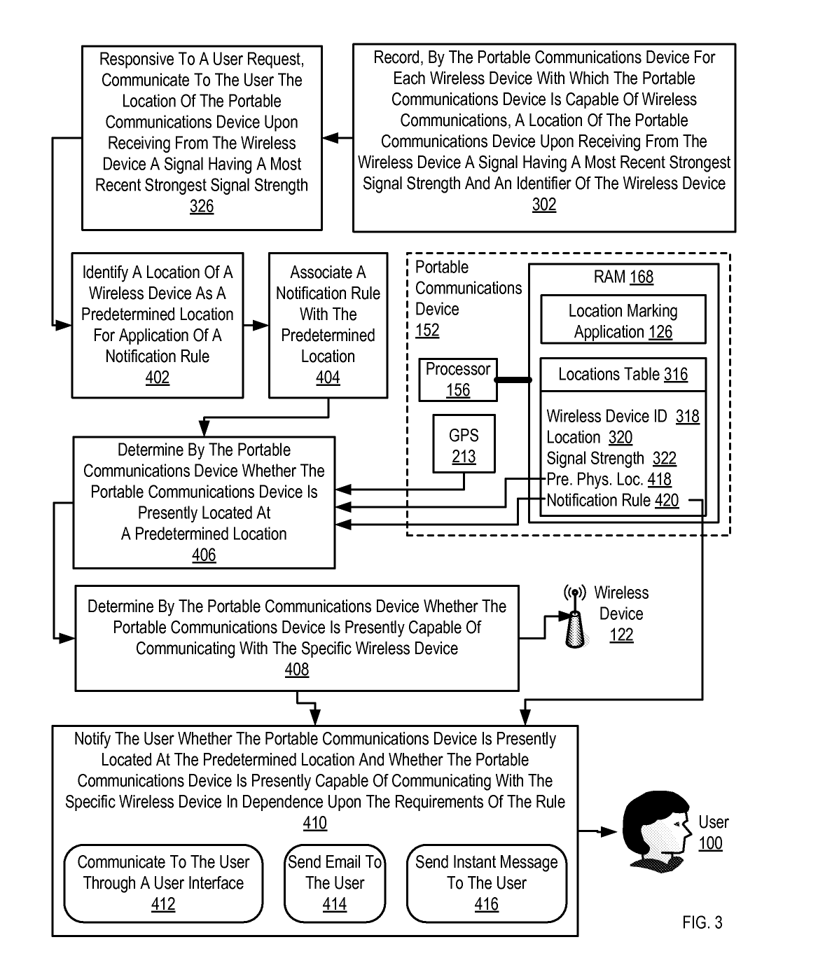

For further explanation, FIG. 3 sets forth a flow chart illustrating a further exemplary method for marking locations with a portable communications device according to embodiments of the present invention. The method of FIG. 3 is similar to the method of FIG. 2, including as it does recording (302) by a portable communications device a location of the portable communications device upon receiving from a wireless device a most recent strongest signal and communicating (306) to a user the location of the portable communications device upon receiving from the wireless device the most recent strongest signal, each of which operates as explained above with reference to the method of FIG. 2. Unlike the method of FIG. 2, however, the method of FIG. 3 also includes, identifying (402), by the portable communications device at the behest of a user, a location of a wireless device as a predetermined location for application of a notification rule. In the method of FIG. 3, the notification rule specifies requirements regarding a specific wireless device and a predetermined physical location. The notification rule (420) of FIG. 3, for example, can be implemented to trigger an alarm when a specific wireless device is separated from the portable communications device by more than a threshold distance. The threshold distance can be specified in the notification rule or established as a general operating parameter of the portable communications device for determining proximity of the portable communications device with any wireless device, for example.

The method of FIG. 3 also includes associating (404) by the portable communication device at the behest of a user, a notification rule with a predetermined location. In the method of FIG. 3, associating a notification rule with a predetermined location includes storing the predetermined physical location (418) and the notification rule (420) together in a single record of the locations table (316) that includes an identifier (318) of a specific wireless device.

The method of FIG. 3 includes determining (406) by the portable communications device whether the portable communications device is presently located at the predetermined location. In the method of FIG. 3, the portable communications device (152) obtains its present location, for example from a GPS transceiver (213) and a predetermined physical location (418) from the locations table (316). The portable communications device (152) subsequently compares its location and the predetermined physical location (418) to determine (406) whether the portable communications device is presently located at the predetermined location, that is, whether the portable communications device is presently located within a threshold distance from the predetermined location.

The method of FIG. 3 also includes determining (408) by the portable communications device whether the portable communications device is presently capable of communicating with the specific wireless device. The portable communications device in FIG. 3 can, for example, retrieve identifiers for all wireless devices that the portable communications device can communicate with, and compare the retrieved identifiers for the wireless device ID (318) associated with the specific wireless device. In the method of FIG. 3, if any of the retrieved identifiers match the wireless device ID (318) associated with the predetermined physical location (418), the portable communications device is presently capable of communicating with the specific wireless device.

The method of FIG. 3 also includes notifying (410) the user (100) whether the portable communications device (152) is presently located at the predetermined location (320) and whether the portable communications device (152) is presently capable of communicating with the specific wireless device (122) in dependence upon the requirements of the rule (420). The portable communications device (152) can communicate (412) with the user through a user interface (180 on FIG. 1), by email (414) through a wireless email client (127 on FIG. 1), by instant messaging through an IM client (129 on FIG. 1), and in other ways as will occur to those of skill in the art. Examples of such notifications include:
Example notification: A user's cell phone notifies a user that the user's credit card is more than 50 feet away from the user's cell phone. Explanation: The credit card is the wireless device, the cell phone improved to mark locations according to embodiments of the present invention is the portable communications device, ‘more than 50 feet from cell phone’ is the predetermined location—with the distance from the cell phone determined by the last recorded location for the credit card identified by the most recent strongest signal from the credit card, and the cell phone has no present capability of communicating with the credit card, all of which indicates that the user has recently misplaced the credit card—because the cell phone has just lost the ability to communicate with the RFID tag on the credit card and has just been transported across the fifty-foot boundary from the most recently recorded location for the credit card.
Example notification: A user's daughter's cell phone notifies the user when the user's daughter (in possession of her cell phone) arrives on her way home from school at a particular bus stop and a particular time period. Explanation: The bus stop, bearing an RFID tag, is the wireless device, the daughter's cell phone, improved for location marking according to embodiments of the present invention, is the portable communications device, the predetermined location is the GPS coordinates of the bus stop, and the present capability of communicating with the wireless device is the cell phone's present capability of communicating with the RFID tag at the bus stop. Conversely, a notification can also be sent if the cell phone of the user's daughter is not within communication range of the bus stop RFID device after a certain pre-determined time slot.

Exemplary embodiments of the present invention are described largely in the context of a fully functional automated system for marking locations with a portable communications device. Readers of skill in the art will recognize, however, that the present invention also may be embodied in a computer program product disposed on computer readable, signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of marking locations with a portable communications device, the portable communications device having a location-sensing capability, the method comprising:
recording, by the portable communications device for each wireless device with which the portable communications device is capable of wireless communications, a location of the portable communications device upon receiving from the wireless device a signal having a most recent strongest signal strength and an identifier of the wireless device; and
responsive to a user request, communicating to the user the location of the portable communications device upon receiving from the wireless device a signal having a most recent strongest signal strength.

2. The method of claim 1 wherein recording further comprises:
recording autonomously upon detecting a presence of a wireless device with which the portable communications device is capable of communicating.

3. The method of claim 1 wherein the wireless device comprises a radio frequency identification (‘RFID’) transceiver.

4. The method of claim 1 wherein the location-sensing capability comprises a global positioning system (‘GPS’) transceiver.

5. The method of claim 1 wherein the portable communications device comprises a user interface, and communicating to the user further comprises communicating to the user through the user interface.

6. The method of claim 1 wherein the portable communications device comprises a wireless email client, and communicating to the user further comprises sending email to the user.

7. The method of claim 1 wherein the portable communications device comprises at least one notification rule specifying requirements regarding a specific wireless device and a predetermined physical location.

8. The method of claim 1 wherein the portable communications device comprises at least one notification rule specifying requirements regarding a specific wireless device and a predetermined physical location, and the method further comprises:
identifying, by the portable communication device at the behest of a user, a location of a wireless device as a predetermined location for application of a notification rule; and
associating, by the portable communication device at the behest of the user, a notification rule with the predetermined location.

9. The method of claim 1 wherein the portable communications device comprises at least one notification rule specifying requirements regarding a specific wireless device and a predetermined physical location, and the method further comprises:
determining by the portable communications device whether the portable communications device is presently located at the predetermined location;
determining by the portable communications device whether the portable communications device is presently capable of communicating with the specific wireless device; and
notifying the user whether the portable communications device is presently located at the predetermined location and whether the portable communications device is presently capable of communicating with the specific wireless device in dependence upon the requirements of the rule.

10. A portable communications device, the portable communications device having a location-sensing capability, the portable communications device comprising a computer processor, a computer memory operatively coupled to the computer processor, the computer memory having disposed within it computer program instructions capable of:
recording, by the portable communications device for each wireless device with which the portable communications device is capable of wireless communications, a location of the portable communications device upon receiving from the wireless device a signal having a most recent strongest signal strength and an identifier of the wireless device; and
responsive to a user request, communicating to the user the location of the portable communications device upon receiving from the wireless device a signal having a most recent strongest signal strength.

11. The portable communications device of claim 10 wherein recording further comprises:
recording autonomously upon detecting a presence of a wireless device with which the portable communications device is capable of communicating.

12. The portable communications device of claim 10 wherein the location-sensing capability comprises a global positioning system (‘GPS’) transceiver.

13. The portable communications device of claim 10 wherein the portable communications device comprises at least one notification rule specifying requirements regarding a specific wireless device and a predetermined physical location.

14. The portable communications device of claim 10 wherein the portable communications device comprises at least one notification rule specifying requirements regarding a specific wireless device and a predetermined physical location, and the computer memory has disposed within it computer program instructions further capable of:
determining by the portable communications device whether the portable communications device is presently located at the predetermined location;
determining by the portable communications device whether the portable communications device is presently capable of communicating with the specific wireless device; and
notifying the user whether the portable communications device is presently located at the predetermined location and whether the portable communications device is presently capable of communicating with the specific wireless device in dependence upon the requirements of the rule.

15. A computer program product for marking locations with a portable communications device, the portable communications device having a location-sensing capability, the computer program product disposed upon a computer-readable, signal bearing medium, the computer program product comprising computer program instructions capable of:
recording, by the portable communications device for each wireless device with which the portable communications device is capable of wireless communications, a location of the portable communications device upon receiving from the wireless device a signal having a most recent strongest signal strength and an identifier of the wireless device; and
responsive to a user request, communicating to the user the location of the portable communications device upon receiving from the wireless device a signal having a most recent strongest signal strength.

16. The computer program product of claim 15 wherein the signal bearing medium comprises a recordable medium.

17. The computer program product of claim 15 wherein the signal bearing medium comprises a transmission medium.

18. The computer program product of claim 15 wherein recording further comprises recording autonomously upon detecting a presence of a wireless device with which the portable communications device is capable of communicating.

19. The computer program product of claim 15 wherein the portable communications device comprises at least one notification rule specifying requirements regarding a specific wireless device and a predetermined physical location.

20. The computer program product of claim 15 wherein the portable communications device comprises at least one notification rule specifying requirements regarding a specific wireless device and a predetermined physical location, and the computer program product further comprises computer program instructions capable of:
determining by the portable communications device whether the portable communications device is presently located at the predetermined location;
determining by the portable communications device whether the portable communications device is presently capable of communicating with the specific wireless device; and
notifying the user whether the portable communications device is presently located at the predetermined location and whether the portable communications device is presently capable of communicating with the specific wireless device in dependence upon the requirements of the rule.
